(19) United States
(12) Patent Application Publication
(10) Pub. No.: US 2019/0056317 A1
(43) Pub. Date: Feb. 21, 2019

(54) DEVICE AND METHOD FOR MEASURING TAR IN A TAR-ENVIRONMENT

(71) Applicant: DANMARKS TEKNISKE UNIVERSITET, Kgs. Lyngby (DK)

(72) Inventors: Sønnik CLAUSEN, Kirke Såby (DK); Alexander FATEEV, Tølløse (DK)

(73) Assignee: Danmarks Tekniske Universitet, Kgs. Lyngby (DK)

(21) Appl. No.: 16/078,730

(22) PCT Filed: Feb. 22, 2017
(86) PCT No.: PCT/EP2017/054008

§ 371 Date: Aug. 22, 2018

(30) Foreign Application Priority Data
Feb. 22, 2016 (EP) 16156675.7

(51) Int. Cl. G01N 21/33; G01N 21/31; G01N 21/3504; G01N 21/85

(52) U.S. Cl. CPC G01N 21/33; G01N 21/314; G01N 21/3504; G01N 2021/8416; G01N 2021/3148; G01N 2021/3155; G01N 2021/3181; G01N 21/85

(57) ABSTRACT

The present disclosure describes a device and corresponding method for measuring tar in a tar environment, e.g., a tar producing environment such as a stove or a combustion engine, based on UV absorption spectroscopy. A first measurement along an optical path in the tar environment is performed at a wavelength less than 340 nm at which both tar and non-tar elements absorb. This measurement is compensated for non-tar absorption by means of a second measurement at a wavelength equal to or greater than 340 nm at which tar does not absorb. From the non-tar compensated absorbance value a measure of tar in the tar environment is derived and an air intake in the tar environment is regulated based on the measure of tar.

### FIELD OF INVENTION

The present disclosure relates to a device and method for measuring tar in a tar-environment, in particular by using UV light. The device and method relates further to measuring inside a tar-environment, for example in order for measuring pollution and/or for regulating the air-intake in order for reducing pollution.

### BACKGROUND OF INVENTION

Smoke from wood stoves is a significant source of air pollution, negatively impacting public health and the environment. Smoke produced from wood stoves comprises over 100 different chemical compounds, many of which are harmful and potentially carcinogenic.

Wood and other biomass smoke pollutants comprise fine particulates, nitrogen oxides, sulfur oxides, carbon monoxide, volatile organic compounds, dioxins, and furans. Breathing air containing wood smoke can cause a number of serious respiratory and cardiovascular health problems.

Fine particulate matter, the very small particles that make up smoke, condensed droplets and soot, may be the most dangerous component of wood smoke pollution. The most harmful particles are those ten microns or less in diameter. These particles can easily be inhaled deep into the lungs, collecting in the tiny air sacs where oxygen enters the blood, causing breathing difficulties and sometimes permanent lung damage. Inhalation of fine particulate matter can increase cardiovascular problems, irritate lungs and eyes, trigger headaches and allergic reactions, and worsen respiratory diseases such as asthma, emphysema, and bronchitis, which could result in premature deaths.

Wood smoke, for example from incomplete combustion, may also comprise a large amount of hydrocarbons, both aliphatic (methane, ethane, ethylene, acetylene) and aromatic (benzene and its derivates, polycyclic aromatic hydrocarbons (PAH)) and heterocyclic compounds. Heavier hydrocarbons may condense as tar—smoke with significant tar content is yellow to brown. Presence of such smoke, soot, and/or brown oily deposits during a fire indicates a possible hazardous situation, indeed being a major health issue and a source of pollution.

Pollution is typically measured using filters, and can typically measure fine particle pollution and heavy particle pollution. Pollution is most commonly measured at measuring stations placed in an area where a pollution analysis is to be performed. For example a measuring station may be in suburbia and measure pollution from for houses near the station, in particular these houses having wood stoves. Measuring stations are not able to indicate where from the pollution is originating. Pollution might as well come from cars or factories nearby. Thus, there is a need for measuring pollution locally.

In order to measure pollution locally, for example from individual households, there is a demand for providing a method and a device to measure pollution. Various devices are able to measure tar and other elements, for example as those described in US 2009/216463, WO 2012/126469 and U.S. Pat. No. 5,691,701. Some devices rely on fluorescence or Raman Spectroscopy. Most devices are rather complex and are not easily integrated or impossible to integrate into for example wood stoves. Use of sensors in combustion engines have however been reported by Casper Christiansen, et al. in “High temperature and high pressure gas cell for quantitative spectroscopic measurements” in Journal of quantitative spectroscopy and radiative transfer, Vol. 169, (2015 Oct. 20), pp. 96-103. Alternative sensors are carbon monoxide sensors which are typically used in large combustions systems and thus not suitable for household monitoring of for example wood stoves. CO sensors are relatively high cost hardware solutions and require frequent service, in particular when the system is based on extractive gas sampling. Thus, there is a need for providing a low-cost solution that is able to directly measure tar and also easily integrated into tar-environments, such as for example wood stoves.

### SUMMARY OF INVENTION

In order to meet the need for a low-cost solution to a tar-measurement, the invention, relates in a first aspect, to a device for measuring tar inside a tar-environment, comprising: at least one light generating element configured for generating light, the device being configured such that the light has: a first wavelength less than 340 nm, whereby light is absorbed by both tar-elements and non-tar elements; and a second wavelength equal to or greater than 340 nm, whereby light is absorbed by non-tar elements, and the device being further configured such that the light has an optical path length through the tar-environment; at least one light detection element for receiving the light from the at least one light generating element and configured for obtaining: a first light signal from the light having the first wavelength less than 340 nm, a second light signal from the light having the second wavelength equal to or greater than 340 nm; a processing unit configured for deducing a first absorbance value from the first light signal and configured for deducing a second absorbance value from the second light signal and relating the second absorbance value to the first absorbance value, thereby obtaining an non-tar compensated absorbance value, and the processing unit further configured for correlating the non-tar compensated absorbance value to a measure of tar inside the tar-environment.

The measure of tar may be an absolute value of tar, such as measured in weight, such as g or mg, or volume such as I or ml. Alternatively, the measure of tar may be a relative value of tar, such as a percentage, for example a percentage of the total content in the tar environment. The measure of tar may in some embodiments be indicated by a colour, for example green if being less than a given threshold, and red if greater than a given threshold.

A major advantage of the device according to the present invention is that it provides a non-tar compensated absorbance value that correlates to the measure of tar. In other words, the measurement as provided by the present invention does not only give an indication or qualitatively measure of tar in the tar-environment, but a quantitative measurement of the tar content. The measure of tar as here disclosed is able to provide detailed information on the pollution of the environment, or detailed information on the quality of a process that generates the tar in the tar-environment. The information as provided by the present invention is indeed more exact than having only a measurement at one wavelength, or two wavelengths that are not related to each other. Thus the present invention provides a very precise measurement of tar.

The device as herein disclosed relies on absorption spectroscopy—a well-known method in the field of element detection. However, the device according to the present invention provides first of all a solution to precise measurement of tar in a tar-environment. Further, the device according to the present invention uses a first wavelength less than 340 nm, i.e. UV light. Since such wavelength can be generated by a low-cost light generating element, there is provided a low cost solution. A light generating element that generates wavelength greater than 340 nm is typically very low cost. Even if the light generating element is an IR light source, such light generating elements are also relatively low cost.

In a second aspect of the invention, the present invention relates to a method for measuring tar inside a tar-environment, comprising the steps of: generating light from at least one light generating element, emitting light into the tar environment such that the light has: a first wavelength less than 340 nm, whereby light is absorbed by both tar-elements and non-tar elements; and a second wavelength equal to or greater than 340 nm, whereby light is absorbed by non-tar elements; directing the light onto at least one light detection element, such that said light has an optical path length through the tar-environment; obtaining a first light signal from the light having the first wavelength less than 340 nm; obtaining a second light signal from the light having the second wavelength equal to or equal to or greater than 340 nm; deducing a first absorbance value from the first light signal; deducing a second absorbance value from the second light signal; deducing a non-tar compensated absorbance value by relating the second absorbance value to the first absorbance value; and correlating the non-tar compensated absorbance value to a measure of tar inside the tar-environment.

In a third aspect of the present invention, there is provided a method for controlling the level of air intake in a tar-environment, comprising the steps of adjusting a level of an air intake based on a measure of tar inside the tar-environment as obtained by the method according to the second aspect of the invention.

By this method is provided means for providing a better combustion, thereby reducing pollution.

The method according to the third aspect of the present invention may be performed by the device according the first aspect of the invention.

### DESCRIPTION OF DRAWINGS

FIG. 1 shows a first embodiment of the device according to the present invention.

FIG. 2 shows a second embodiment of the device according to the present invention.

FIG. 3 shows a third embodiment of the device according to the present invention.

FIG. 4 shows a fourth embodiment of the device according to the present invention.

FIG. 5 shows a fifth embodiment of the device according to the present invention.

FIG. 6 shows an embodiment of the device according to the present invention as implemented in a tar-environment.

FIG. 7 shows another embodiment of the device according to the present invention as implemented in a tar-environment.

FIG. 8 shows yet another third embodiment of the device according to the present invention as implemented in a tar-environment.

FIG. 9 shows several implementations of a device according to the present invention as implemented in a stove.

FIG. 10 shows an absorption curve and spectral ranges where tar elements and non-tar elements can be measured in the device according to the present invention.

FIG. 11 shows an absorption curve and how three measurements can be used in the present invention.

### DETAILED DESCRIPTION OF THE INVENTION

In a preferred embodiment of the device, relating to the first aspect of the present invention, the device is configured for performing the method according to the second aspect of the invention.

The device and method as disclosed herein is related to a direct measure of tar, meaning that the measurement is done directly inside the tar-environment, in contrast to non-direct measurement, such as in extracted gas analysis outside the tar-environment.

An absorbance value for tar-elements and non-tar elements may in one embodiment be given as A₁=log₁₀(I_{ref,1}/I₁), where I₁ is the intensity at the wavelength less than 340 nm transmitted through the tar-environment when tar-elements and non-tar elements are present (using the wavelength less than 340 nm may provide an absorbance value for both tar-elements and non-tar elements as these elements may absorb the light with the wavelength less than 340 nm) and I_{ref,1} is the intensity at the wavelength less than 340 nm transmitted through the tar-environment when neither tar-elements nor non-tar elements are present. In other words, I_{ref,1} is a reference intensity that may be measured or determined before the device is set to measure tar.

Similarly, an absorbance value for non-tar elements may in one embodiment be given as A₂=log₁₀(I_{ref,2}/I₂), where I₂ is the intensity at the wavelength equal to or greater than 340 nm transmitted through the tar-environment when tar-elements and non-tar elements are present (using the wavelength equal to or greater than 340 nm may provide an absorbance value for non-tar elements, only, as these elements may also absorb the light with the wavelength equal to or greater than 340 nm) and I_{ref,2} is the intensity at the wavelength equal to or greater than 340 nm transmitted through the tar-environment when neither tar-elements nor non-tar elements are present. In other words, I_{ref,2} is a reference intensity that may be measured or determined before the device is set to measure tar.

According to the first aspect, the processing unit is configured for deducing a first absorbance value from the first light signal and configured for deducing a second absorbance value from the second light signal. Accordingly, in one embodiment of the present invention, the light signal may be intensity. Thus, following the above embodiments of how the absorbance value may be defined, the processing unit may in one embodiment be configured for processing the intensities as produced from the light on the detecting elements, using the relationships A₁=log₁₀(I_{ref,1}/I₁) and A₂=log₁₀(I_{ref,2}/I₂) for the first and second absorbance value, respectively. In other words, the processing unit may perform mathematical operations in order to deduce the first and second absorbance value. Furthermore, according to the present invention, the processing unit is configured for relating the second absorbance value to the first absorbance value, thereby obtaining a non-tar compensated absorbance value. In one embodiment, this relating may be by subtracting the two values from each other, i.e. such that the non-tar compensated absorbance value is A_{c}=A₁−A₂. However, various mathematical operations may be performed in order to relate the two absorbance values to each other. Also, various definitions of absorbance values may be given to define the absorbance value, for example, a raw signal or a processed signal.

As just described above, the absorbance value may be the intensity normalized by the reference intensity. In relation hereto, the absorbance value is a processed signal.

The absorbance value may also be a raw signal, for example the intensity as read out directly from the at least one light detection element.

The absorbance value may refer to the well-known measures “absorbance” as above described being A₁=log₁₀(I_{ref,1}/I₁) and/or as also describe above, the thereto related value normalized intensity, known as the “transmittance” which is the value inside the parenthesis, i.e. T=I_{ref,1}/I₁.

Accordingly, the non-tar compensated absorbance value may be obtained from the raw signals from the first and second light signals, for example denoted by S₁ and S₂. The two absorbance values, in this case S₁ and S₂, may for example be related to each other by a subtraction, such that the non-tar compensated tar signal is S₁-S₂. Alternatively, the two absorbance values, in this case, S₁ and S₂, may for example be related to each other by a subtraction where S₂ has been multiplied with a gain factor, g, such that the non-tar compensated tar signal is S₁−g·S₂. The gain factor may be equal to or greater or less than 1, and in most cases, it is greater than 1, such as 1.1, such as 1.2, such as 1.3, such as 1.4, such as 1.5 or such as 2.

Finally, also according to the present invention, the processing unit is further configured for correlating the non-tar compensated absorbance value to a measure of tar in the gas inside the tar-environment. In one embodiment, such a correlation may for example be obtained by using the Lambert Beer law, for example such that the measure of tar is related to the concentration of tar in the tar-environment.

Further details of the specific features are described in the following.

Tar-Environment

In general the tar-environment may be an environment with tar. More specifically, the tar-environment may also be a tar-producing environment. A wood stove has already been described as an example of a tar-producing environment that is also a tar-producing environment.

In other embodiments of the present invention, the device may be used in the tar-environment selected from the group of: engines, in particular combustion engines, such as gasoline engines and diesel engines, such as in cars, ships and trucks; stoves, in particular wood stoves and wood pellet stoves; fuel cells, gasification units and other syngas producing units.

In some embodiments of the present invention, the device may be used in the tar-environment being a channel that is fluidly connected to the tar-environment, such as an exhaust pipe and/or a chimney. For example, the device may be used on part of the chimney, i.e. the tube going from the wood stove to the chimney. This tube may typically be accessible.

Tar and Tar-Elements

Tar as herein defined is a condensable organic residue present in a smoke from a combustion/gasification/pyrolysis process. Tar is normally build from PAH's (Polycyclic Aromatic Hydrocarbons). The later consist from homo/heterocyclic aromatics with at least one benzene ring. Tar absorption starts below 400 nm, but most significant can be found below 280 nm and correspond to π-π* transitions of conjugated double bonds in PAH's.

Non-Tar Elements

The non-tar elements as disclosed herein may refer to particles, such as soot, coarse particles and particulate matter (PM). Soot is a product of further growth of the PAH's. It's a carbonaceous solid material, many of which contain appreciable amounts of hydrogen as well other elements and compounds that may have been present in the original fuel. Soot size ranges from few nm (nanoparticles) and up to about 2.5 μm. Above 340 nm, soot particles give nearly wavelength-independent absorption spectra. Particles larger than 2.5 um are considered to be as coarse or as PM those have no spectral dependence in the absorption spectra and simply attenuate light like a (metal) mesh. Therefore preferred wavelengths for soot/particles measurements can be any from 340 nm to 500 nm.

In tar-free environments, measurements at 266 nm or below 266 nm (up to 200 nm) can be used for quantification of soot nanoparticles together with soot measurements in 340-500 nm.

Light

In one embodiment of the invention, as has already been disclosed, the light may also be used to provide a reference measurement when tar is not present in the tar-environment. For example, the reference measurement may be done when the tar-environment, in case of a tar-producing environment, such as a wood stove, is simply not burning. The status of when tar is not present in the tar-environment may be sensed by the device, for example using a measuring device, such as a temperature measuring device. Alternatively, and or additionally, the status of when tar is not present in the tar-environment may also be communicated to the device, when for example the tar-environment, such as a stove or an engine, is not in operation mode.

Preferably, the light as disclosed herein is collimated, for example obtained by a collimator. The collimator may be integrated into the light generating element, or an external unit. Typically, a light emitting diode comprises a collimator.

The light with a wavelength may in some embodiments be less than 340 nm, preferably between 200 nm and 290 nm, such as between 230 nm and 285 nm. The ranges as here disclosed corresponds to ranges where tar has a strong absorption.

Light Generating Element and Light Detection Element

In a most preferred embodiment, the device is being configured such that the light has a third wavelength greater than 340 nm, and wherein the at least one light detection element for receiving the light from the at least one light generating element is configured for obtaining a third light signal from the light having the third wavelength greater than 340 nm, and wherein the processing unit is configured for deducing a third absorbance value from the third light signal such that the third wavelength and the third absorbance values allows for deduction of the non-tar compensated absorbance. The non-tar compensated absorbance value as obtained by this embodiment may be more precise than using two wavelengths. This is exemplified in the following. As previously described, the non-tar compensated absorbance value may for example be deduced by the relation S_{c}=S₁−-g·S₂, where g is a gain factor. By using three wavelengths as described above, it may be possible to deduce the non-tar compensated absorbance value by the following formula: S_{c}=S₁−S₂−(S₂−S₃)/(λ₂−λ₃)·(λ₁−λ₂) which may be approximated to the previous and less accurate expression S_{c}=S₁−g·S₂. Thus, as can be seen from this example, a more precise measurement may be achieved using three wavelengths.

In one embodiment of the present invention, the at least one light generating element is a ultra-violet (UV) light emitting diode (LED) and/or a UV lamp. For example, the LED may be an AlGaN multi-quantum-well (MQW), specifically emitting light with 226-273 nm. In an alternative embodiment of the present invention, the at least one light generating element is a multi-colour LED configured to at least emit light with the first wavelength and the second wavelength. Additionally, the multi-colour LED may be configured to emit light with a third wavelength greater than 340 nm.

In a second embodiment of the present invention, the at least one light generating element is an infrared (IR) light source. In some embodiments, the at least one light generating element may both be UV light source and an IR light source.

In a third embodiment of the present invention, the at least one light generating element is configured to be modulated. Modulation of the light element may allow significant life-time extension of a UV LED/lamp light source. Modulation may also remove background radiation influence on a measured signal, for example an IR signal.

In some embodiments of the present invention, the at least one light generating element is a tunable light source or/and broad-band light-source. In these embodiments, the tunable light source may be configured with a tunable range from below 340 nm to above 340 nm, such that a single light source may be used. In the case of a broad-band light source, there may be filters to provide the wavelength of less than 340 nm and above 340 nm, such that a single light source may be used. A rotating element with filters may also be used to provide the wavelength of less than 340 nm and above 340 nm, such that a single light source may be used.

In one embodiment of the present invention, the light detection element is a photodiode, such as a Si-photodiode or a GaP-photodiode.

In another embodiment of the present invention, the device further comprise an optical fibre and the least one light generating element and/or light detection element is/are optically connected to an optical fibre. An advantage of this embodiment is that the light generating element and/or light detection element need not to be mounted to the tar-environment. This may for example be a way of providing a setup in very hot tar-environments, where the light generating element and/or light detection element are not configured for being in contact with the a very hot tar-environment, for example an exhaust pipe.

In yet another embodiment of the present invention, the at least one light generating element and the at least one light detection element are placed adjacent each other, for example on the same side of an exhaust pipe.

In alternative embodiments, the at least one light generating element and/or the at least one light detection element is/are inside the tar-environment. For example, the elements may be inside a tube connected to an exhaust pibe or a chimney.

Additional Elements

In one embodiment of the present invention, the at least one light generating element and at least one light detection element each comprise an optical window and/or a lens that is configured to resist heat from the tar-environment. This may facilitate that measurements may be performed inside tar-environment, such as in tar-producing environments, where burning of a material may take place.

In a second embodiment of the present invention, the optical window and/or the lens is/are configured with means for letting ambient air onto the surface of the optical window and/or the lens, wherein the surface is facing the tar-environment. When a material is burned in an oven or stove or engine, it is most likely that soot or other materials deposit on the inner walls of the oven or stove or engine. In order to carry out an optical detection inside the oven or stove or engine, clear windows are preferred, at least for a large optical signal. Thus, ambient air being let into the surface of the window and/or lens may facilitate clean optical access.

In another embodiment of the present invention, the device further comprises a corner cube configured to redirect the light from the at least one light generating element towards the light detection element. An advantage of this embodiment may be that the light generating element and the light detection element may be close to each other. Another advantage may be that a longer optical path is obtained and a third advantage may be than it is easier to install.

In yet another embodiment of the present invention, the device comprises two light sources and/or two light detections elements. A first light source may emit light with a wavelength less than 340 nm, and a second light source may emit light with a wavelength equal to or greater than 340 nm. The two light sources may optically share a common beam splitter, for example to redirect light to a single light detection element.

In an alternative embodiment, the two light detection elements optically share a common beam splitter.

In a preferred embodiment, the device further comprising a porous tube located between at least one light generating element and the at least one light detection element, such that the optical path length is within the porous tube. The porous tube may be a porous ceramic, glass filter or porous metal tube with typical pore size 0.1 μm to 100 μm. An advantage of this embodiment may be that large particles (soot, ash, etc.) may be removed from the optical path, thereby providing a measurement that is not affected by the influence of large particles. The tube may also protect any optical access to a light generating element and a light detecting element, such as a window and/or a lens.

In a more preferred embodiment of the present invention, the porous tube is coupled with a gas inlet, such that the porous tube can be flushed with the gas to provide a reference measurement at least without tar-elements such that the first absorbance value and second absorbance can be deduced with the reference measurement. An embodiment of how this can be accomplished is previously described.

In a most preferred embodiment of the present invention, the device comprises a temperature measuring unit, such a thermocouple configured to measure the temperature inside the tar-environment. Information related to the temperature may be incorporated into the processing unit such that a more precise deduction of absorbance values can be performed and converted to absolute concentration.

Processing Unit

In one embodiment of the present invention, the processing unit is placed outside the tar-environment. The processing unit may also be thermally insulated from the tar-environment. An example of a processing unit may be a FPGA device, a CPU or a computer.

Controller

In a preferred embodiment of the present invention, the device further comprises a controller, wherein the controller is configured to regulate an air intake into the tar-environment based on the measure of tar inside the tar-environment. Examples of a controller may be a motor, or an actuator, or any kind of opening/closing mechanism. This embodiment may facilitate cleaner combustion and/or burning, and/or more optimal combustion and/or burning. Thereby is provided a solution to less pollution. Because the measurement is based on tar, as produced when air is not present or not enough, the regulation is based directly on the effect of low air content relative to the burning process. Alternative regulations of air typically depend on CO, for example using a measurement with a wavelength equal to or greater than 340 nm, such as an infrared light source. However, an IR sensor measuring CO alone is sensitive to other elements, and thus not as precise as the device according to the present invention. Further, CO is an indicator of many processes, and not only related to generation of tar. Thus, the present invention provides an alternative to an optical CO sensor that is more reliable and directly related to the production of tar and pollution. Regulation of air intake based on tar measurement provides a more efficient regulation of air than a CO measurement. For example, although CO and tar are strongly correlated, there are situations such as with pure char combustion, where CO and tar are not correlated.

Method

In one embodiment of the second aspect of the invention, the method is performed by the device according the first aspect of the invention.

In a second embodiment of the method according to the second aspect of the invention, the step of deducing the first absorbance value and/or the second absorbance value is based on the optical path length between the at least one light generating element and the at least one light detection element. In other words, the deduction may be based on the Lambert-Beer law. Accordingly, the step of correlating the non-tar compensated absorbance value to a measure of tar may be based on dimensions of the tar-environment.

In an alternative embodiment of the present invention, the step of correlating the non-tar compensated absorbance value to a measure of tar is based on a reference measurement with a standardised non-directly measuring device, such as a device that is cooling a gas and/or smoke. This approach is more empirical than based on a formula such as the Lambert-Beer law, but may be an easier implementation.

In some embodiments, the method further comprising the step of emitting light into the tar environment such that the light has a third wavelength greater than 340 nm; obtaining a third light signal from the light having the wavelength greater than 340 nm; deducing a third absorbance value from the third light signal; and deducing a non-tar compensated absorbance value by relating the third absorbance value to the second absorbance value. This may provide a more precise measurement and better deduction of non-tar compensated absorbance value.

### Example 1—Basic Setup

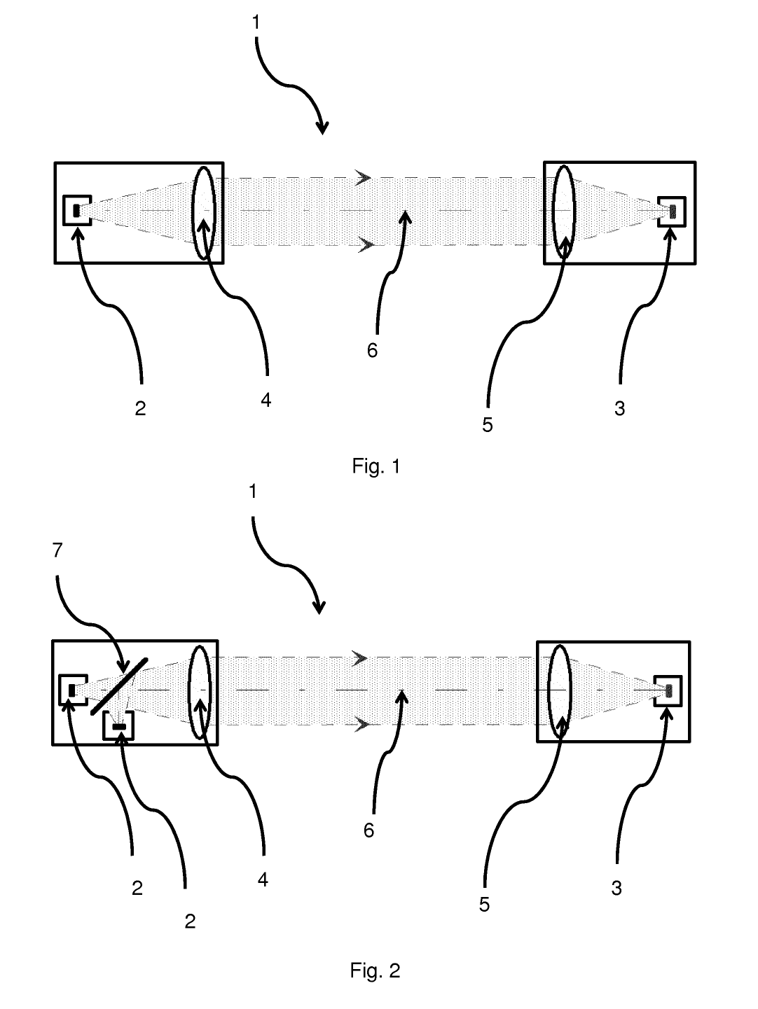

FIG. 1 shows a basic setup of the device 1 according to the present invention. There is a light generating element 2, a light detection element 3. The processing unit is not shown in this figure. The light generating element 2 as shown has a collimating lens 4 integrated into a light generating assembly. The light detection element 3 as shown has a focusing lens 5 integrated into a light detection assembly. The light defining the optical path length 6 is collimated.

### Example 1—Setup with a Beam Splitter

FIG. 2 shows a variant of the basic setup according to FIG. 1, where there is a beam-splitter 7 in optical connection with two light generating elements 2.

### Example 3—Setup with a Corner Cube

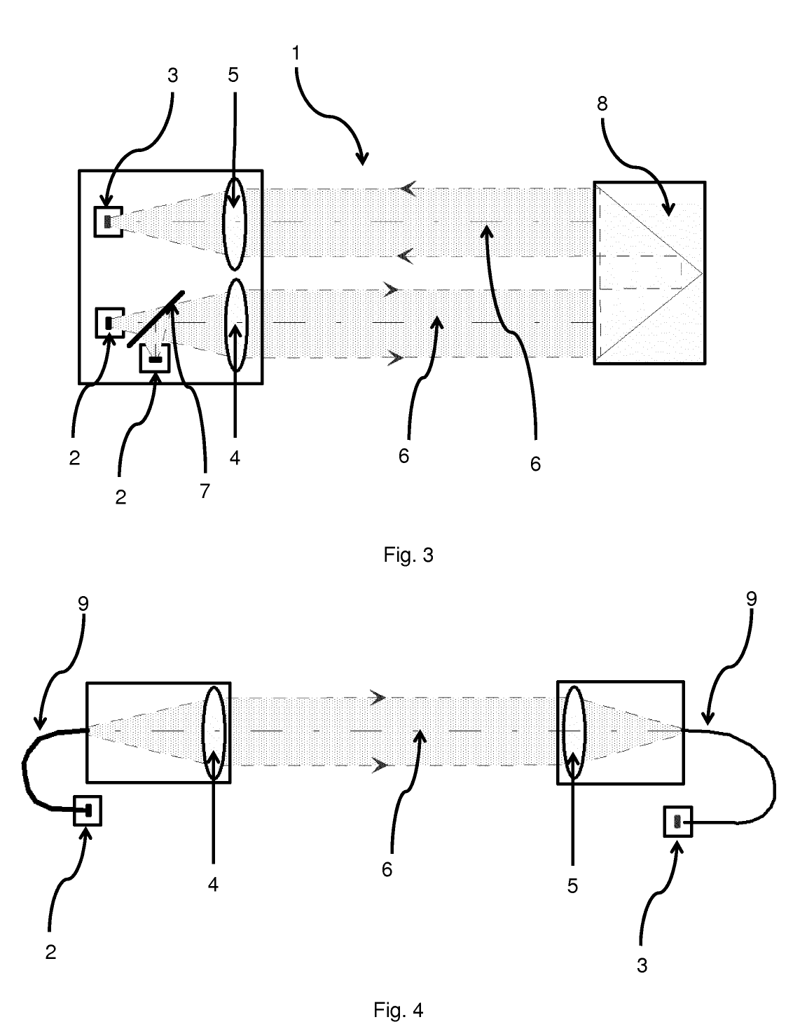

FIG. 3 shows a variant of the setup according to FIG. 2, where there is a corner cube 8 directing the light to a single light detection element 3, such that the two light generating elements 2 and the single light detection element 3 can be integrated into a single assembly.

### Example 4—A Setup with Optical Fibres

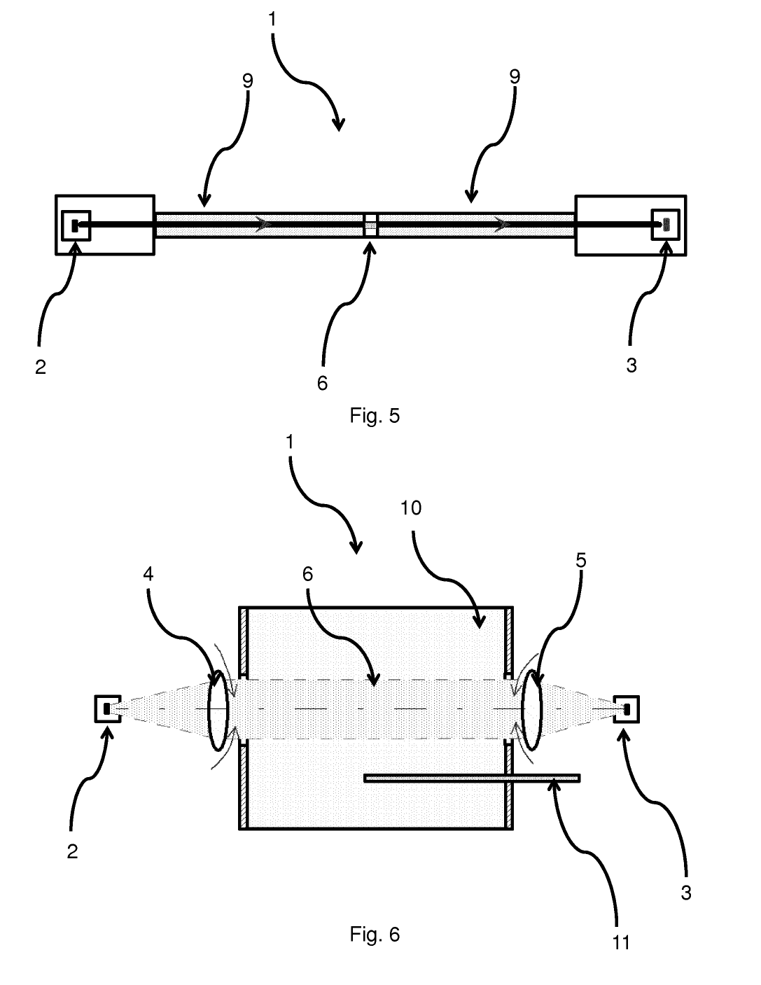

FIG. 4 shows a variant of the basic setup according to FIG. 1, where the one light generating element 2 and the one light detection element 3 each are optically connected to an optical fibre 9, in this case allowing the light generating element 2 and light detection element 3 to be placed further away from the tar-environment, being part of the optical path 6.

### Example 5—Another Setup with Optical Fibres

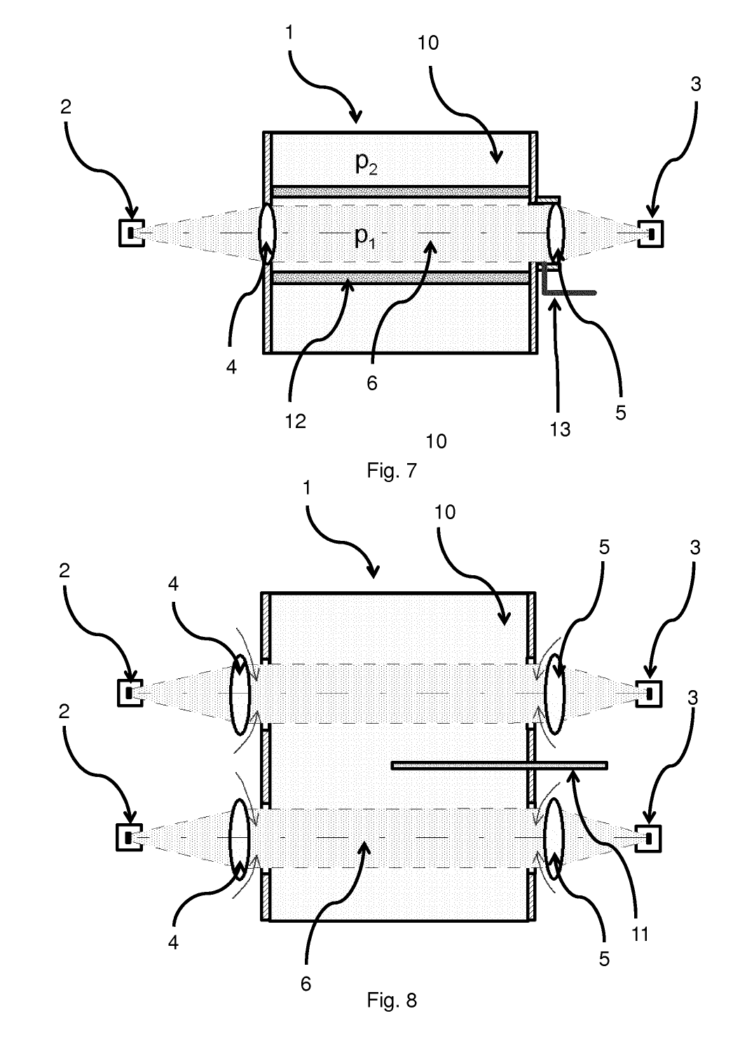

FIG. 5 shows a variant of the basic setup according to FIG. 1, where the one light generating element 2 and the one light detection element 3 each are optically connected to an optical fibre 9, in this case such that the fibres 9 are a part of the optical path 6, and such that there is a gap between the fibres 9, wherein tar can be measured.

### Example 6—A Setup in a Tar-Environment

FIG. 6 shows a variant of the basic setup according to FIG. 1, where a tar-environment 10 is shown. Further, as indicated by arrows, there is ambient air let into the surfaces of the lenses 4 and 5, the surfaces facing the tar-environment, thereby providing means for clean surfaces. There is also shown a thermo-couple 11 inserted into the tar-environment to measure the temperature of the gas and/or smoke.

### Example 6—Another Setup in a Tar-Environment

FIG. 7 shows a variant of the basic setup according to FIG. 1, where a tar-environment 10 is shown. Further, there is a porous tube 12 located between the one light generating element 2 and the one light detection element 3, such that the optical path length 6 is within the porous tube. There are pressures P1 and P2 and a gas inlet 13 is coupled to the porous tube for flushing air though the porous tube 12. A controlled gas inlet flow can be used to dilute tar concentration in the optical path if absorption signal is too strong, e.g. in gas from a gasifier with several percent tar.

### Example 8—A Third Setup in a Tar-Environment

FIG. 8 shows a variant of the basic setup according to FIG. 1, where a tar-environment 10 is shown. In this embodiment, there are two light generating elements 2 and two light detecting elements 3. One of the light generating elements 2 generate light with a wavelength less than 340 nm, and the other light generating element 2 generate light with a wavelength equal to or greater than 340 nm. There is also shown a thermo-couple 11 inserted into the tar-environment to measure the temperature of the gas as the absorption of tar depends on the temperature. Total tar mass flow can be estimated by measured tar concentration and the gas velocity extracted from signals. The tar signal varies in time as it has a turbulent nature, i.e. a characteristic time scale of signals can be found (from a time correlation). The velocity is given by the distance between the two separated sensors divided by the characteristic time scale.

### Example 9—A Setup in Wood Stove

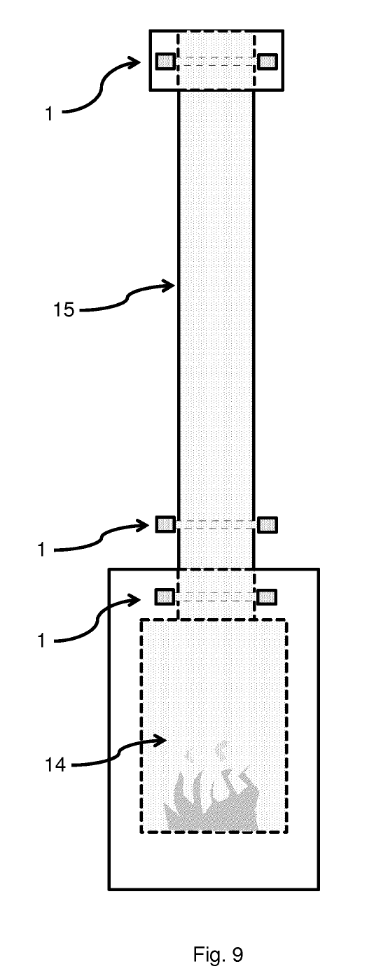

FIG. 9 shows three possible places to locate the device 1 according to the present invention into a tar environment. In this example the tar-environment is a tar-producing environment, here shown as a wood stove. The device 1 can be installed into the wood stove directly in the wood stove 14, and/or in the chimney 15, close to the wood stove and/or far from the wood stove, i.e. at the end part of the chimney 15.

### Example 10—Absorption Curve

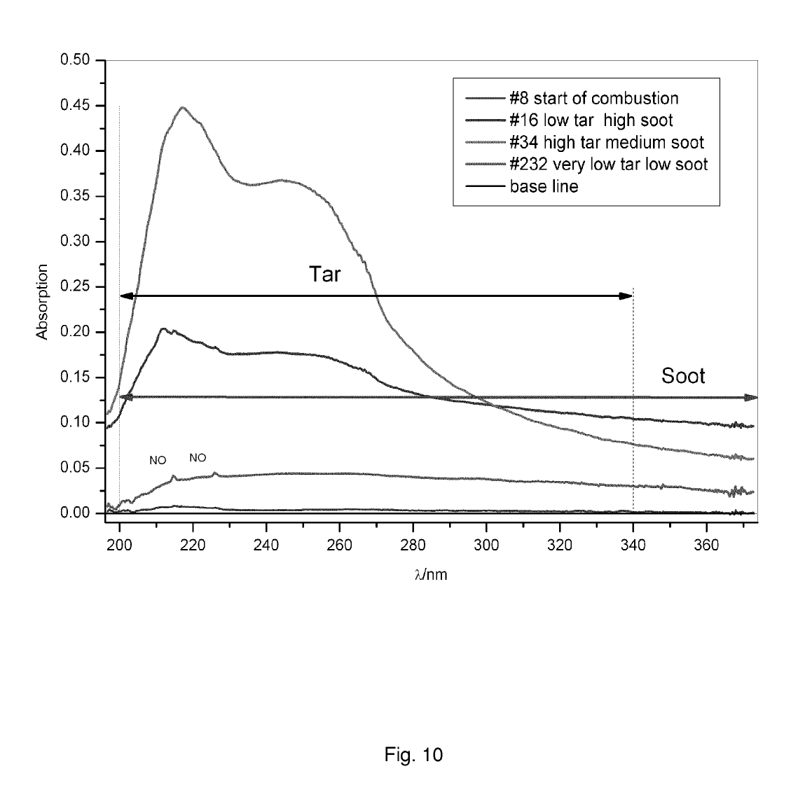

FIG. 10 shows UV absorption spectra at various stages of wood combustion. Tar elements are possible to measure in the range from 200 nm to 340 nm, however preferably between 230 nm and 285 nm, most preferably at 266 nm. Non-tar elements are present in the range from 200 nm to 500 nm, and soot is specifically found at 340-500 nm as indicated on the figure. The non-tar compensated absorbance value according to the present invention is in this example understood to be a soot-compensated absorbance value.

### Example 11—Measurements Using Three Wavelengths

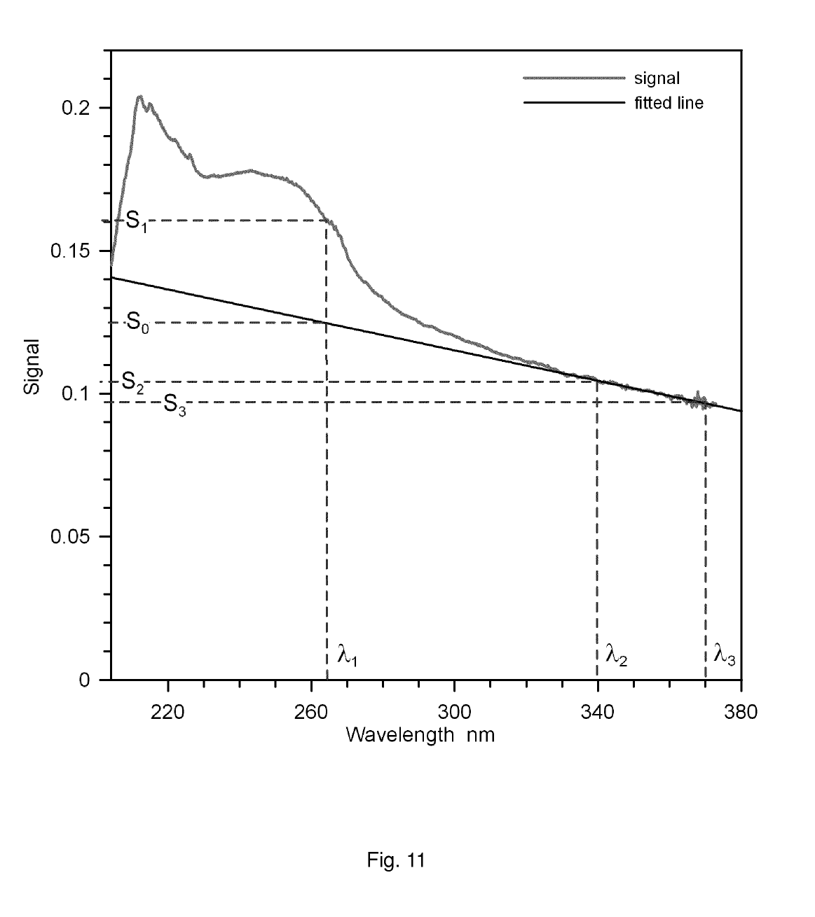

FIG. 11 shows an example of how the three wavelengths relate to a measurement of tar-elements and non-tar elements. Using three wavelengths allows deducting the non-tar compensated absorbance value by the following formula: S_{c}=S₁−S₂−(S₂−S₃)/(λ₂−λ₃)·(λ₁−λ₂). This example demonstrates that it is possible to obtain a more precise measurement than using two wavelengths. Absorption of solid particles can in a certain spectral range be approximated by a line (the black line). The raw tar signal (S₁) should be compensated to find the true tar signal. Compensation may require one or two measurements at or above 340 nm to find the offset and slope of the line. Using two measurements at or above 340 nm is less precise than the 3 wavelength method, i.e. where the raw tar signal is corrected only by S₂ and a gain factor g. The gain factor g is approximately 1.2 in this example. Accordingly, the true tar signal, i.e. the non-tar compensated absorbance value is in this example approximated to be S_{c}=S₁−g·S₂=0.16−1.2·0.105=0.16−0.126=0.034. The more correct value is S₁−S₀=0.035 as is obtainable by using the three absorbance values. The measure of tar is in case this the raw signal, i.e. related to the intensity. In other words, the value of 0.035 is the non-tar compensated absorbance value which has not yet been correlated to the measure of tar. Correlation to a measure of tar may be obtained by converting the value of 0.035 to a content of tar defined in mg, for example by a conversion table or an equation, for example a multiplication factor.

1-29. (canceled)

30. A device for measuring tar inside a tar-environment, comprising:
at least one light generating element configured for generating light,
the device being configured such that the light has:
a first wavelength less than 340 nm, whereby light is absorbed by both tar-elements and non-tar elements; and
a second wavelength equal to or greater than 340 nm, whereby light is absorbed by non-tar elements, and
the device being further configured such that the light has an optical path length through the tar-environment;
at least one light detection element for receiving the light from the at least one light generating element and configured for obtaining:
a first light signal from the light having the first wavelength less than 340 nm,
a second light signal from the light having the second wavelength equal to or greater than 340 nm;
a processing unit configured for deducing a first absorbance value from the first light signal and configured for deducing a second absorbance value from the second light signal and relating the second absorbance value to the first absorbance value, thereby obtaining an non-tar compensated absorbance value, and the processing unit further configured for correlating the non-tar compensated absorbance value to a measure of tar in the gas inside the tar-environment; and
a controller, wherein the controller is configured to regulate an air intake into the tar-environment based on the measure of tar inside the tar-environment.

31. The device according to claim 30, wherein the light is used to provide a reference measurement when tar is not present in the tar-environment.

32. The device according to claim 30, wherein the at least one light generating element is a ultra-violet (UV) light emitting diode and/or a UV lamp or an infrared (IR) light source.

33. The device according to claim 30, wherein the at least one light generating element is configured to be modulated.

34. The device according to claim 30, wherein the at least one light generating element is a tunable light source or/and broad-band light source.

35. The device according to claim 30, wherein the at least one light generating element and the at least one light detection element are placed adjacent each other.

36. The device according to claim 35, further comprising a corner cube configured to redirect the light from the at least one light generating element towards the light detection element.

37. The device according to claim 30, wherein the at least one light generating element and at least one light detection element each comprises an optical window and/or a lens that is configured to resist heat from the tar-environment.

38. The device according to claim 37, wherein the optical window and/or the lens is/are configured for letting ambient air onto the surface of the optical window and/or the lens, wherein the surface is facing the tar-environment.

39. The device according to claim 30, comprising two light sources and/or two light detections elements.

40. The device according to claim 39, wherein the two light sources or the two light detection elements optically share a common beam splitter.

41. The device according to claim 30, further comprising a porous tube located between at least one light generating element and the at least one light detection element, such that the optical path length is within the porous tube.

42. The device according to claim 41, wherein the device further comprises a gas inlet and the porous tube is coupled with the gas inlet, such that the porous tube can be flushed with the gas to provide a reference measurement at least without tar-elements such that the first absorbance value and second absorbance can be deduced with the reference measurement.

43. The device according to claim 30, configured such that the light has a third wavelength greater than 340 nm, and
wherein the at least one light detection element for receiving the light from the at least one light generating element is configured for obtaining a third light signal from the light having the third wavelength greater than 340 nm, and
wherein the processing unit is configured for deducing a third absorbance value from the third light signal, such that the third wavelength and the third absorbance values allows for deduction of the non-tar compensated absorbance.

44. A method for measuring tar inside a tar-environment and for controlling a level of air intake in the tar-environment, comprising the steps of:
generating light from at least one light generating element,
emitting light into the tar environment such that the light has:
i. a first wavelength less than 340 nm, whereby light is absorbed by both tar-elements and non-tar elements; and
ii. a second wavelength equal to or greater than 340 nm, whereby light is absorbed by non-tar elements;
directing the light onto at least one light detection element, such that said light has an optical path length through the tar-environment;
obtaining a first light signal from the light having the wavelength less than 340 nm;
obtaining a second light signal from the light having the wavelength equal to or greater than 340 nm;
deducing a first absorbance value from the first light signal;
deducing a second absorbance value from the second light signal;
deducing a non-tar compensated absorbance value by relating the second absorbance value to the first absorbance value;
correlating the non-tar compensated absorbance value to a measure of tar inside the tar-environment; and
adjusting the level of the air intake based on the measure of tar inside the tar-environment.

45. The method according to claim 44, wherein the method further comprising the step of emitting light into the tar environment such that the light has a third wavelength greater than 340 nm; obtaining a third light signal from the light having the wavelength greater than 340 nm; deducing a third absorbance value from the third light signal; and deducing a non-tar compensated absorbance value by relating the third absorbance value to the second absorbance value.

46. The method according to claim 44, wherein the step of deducing the first absorbance value and/or the second absorbance value is based on the optical path length between the at least one light generating element and the at least one light detection element.

47. The method according to claim 44, wherein the step of correlating the non-tar compensated absorbance value to a measure of tar is based on dimensions of the tar-environment.

48. The method according to claim 44, wherein the step of correlating the non-tar compensated absorbance value to a measure of tar is based on a reference measurement with a standardised non-directly measuring device, such as a device that is cooling the gas.

49. The method according to claim 44, wherein the tar-environment is selected from the group of:
combustion engines;
a channel that is fluidly connected to an exhaust pipe and/or a chimney;
wood stoves or wood pellet stoves; and
fuel cells, gasification units or other syngas producing units.
